(19) United States
(12) Patent Application Publication
(10) Pub. No.: US 2026/0102759 A1
(43) Pub. Date: Apr. 16, 2026

(54) POLYCRYSTALLINE-IRON-LOADED POROUS BIOCHAR AEROGEL CATALYST AND PREPARATION METHOD AND APPLICATION THEREOF

(71) Applicant: Wenzhou University, Wenzhou (CN)

(72) Inventors: Renlan LIU, Wenzhou (CN); Xiaoyong Wang, Wenzhou (CN); Xiangyong Zheng, Wenzhou (CN); Min Zhao, Wenzhou (CN); Tadayuki Fujii, Fukuoka-city (JP); Dongdong Cheng, Wenzhou (CN)

(21) Appl. No.: 18/934,806

(22) Filed: Nov. 1, 2024

(30) Foreign Application Priority Data
Oct. 16, 2024 (CN) 202411440770.8

(51) Int. Cl. B01J 27/20; B01J 23/745; B01J 35/23; B01J 35/45; B01J 35/57; B01J 35/61; B01J 35/64; B01J 37/04; B01J 37/08; B01J 37/32

(52) U.S. Cl. CPC B01J 27/20; B01J 23/745; B01J 35/23; B01J 35/45; B01J 35/57; B01J 35/615; B01J 35/657; B01J 37/04; B01J 37/084; B01J 37/32; B01J 2235/10

(57) ABSTRACT

The present invention discloses a polycrystalline-iron-loaded porous biochar aerogel catalyst and a preparation method and application thereof, and pertains to the field of preparation of carbon catalysts. The polycrystalline-iron-loaded porous biochar aerogel catalyst in the present invention comprises a porous biochar substrate. Polycrystalline iron nanoparticles are loaded on biochar layers through Fe—C bonds, and the porous biochar aerogel has an internal structure that is an overall honeycomb-like porous network structure. The preparation method of the catalyst in the present invention utilizes ion exchange of crosslinking agents to crosslink iron-based materials with carbon-based materials, and accomplishes the preparation through treatments of freeze-drying and high-temperature calcination.

### TECHNICAL FIELD

The present invention belongs to the technical field of wastewater treatment. To be more specific, it particularly relates to a polycrystalline-iron-loaded porous biochar aerogel catalyst and a preparation method and application thereof.

### BACKGROUND

With the progress of science and technology in China and the development of the society, environmental issues have gradually become obstacles to the economic growth in the country. Water shortage and pollution become increasingly prominent, and various new kinds of toxic and harmful substances continue to emerge. Among them, emerging pollutants are typical organic pollutants that are relatively concerned in the field of water environment management at present. Although they exist in low concentrations in water, the emerging pollutants pose significant risks since they can affect the endocrine and genetic systems of humans and other organisms. The potential harm of the emerging pollutants to the ecosystem and human health has become a significant research focus in the field of water treatment this century. Therefore, there is a need to develop a method that is simple in process, low in cost, and free of residues and secondary pollution to remove the emerging pollutants from water. Ozone, with its strong oxidative properties, can be used to remove color and odor from water and disinfect water, and has been widely applied in projects for restoration of water polluted by organic matters.

Although ozone has relatively strong oxidizing ability, it is often difficult to achieve an ideal effect when treating some organic matters that have complex structures. Additionally, when it comes to the treatment of some hard-to-degrade organic matters, it is often the case that a large amount of ozone needs to be added or a relatively long time needs to be taken before realizing complete degradation, which undoubtedly increases treatment costs. Thus, it is particularly important to catalyze ozone oxidation.

Characteristics of catalysts are the most crucial factor that influences the course and effect of heterogeneous catalytic ozonation. Currently, researchers in China and abroad have conducted extensive research to develop innovative catalysts to improve the efficiency of the heterogeneous catalytic ozonation, such as alumina, natural zeolite, reduced graphene oxide, different metal-supported catalysts, and metal oxides among other catalysts that have been used in the course of catalytic ozonation. At the same time, since iron-based materials are easy to synthesize and good in catalytic performance and iron is available in nature, the iron-based materials are commonly used as catalysts for the heterogeneous catalytic ozonation. In a catalytic ozonation system, the synthesis and application of iron-based materials with novel features and functions have been widely studied, and developing a stable iron-based material to sustainably promote the ozone oxidation is of great significance.

As a result, the method of fixing transition metals onto biochar has gained considerable attention from researchers at home and abroad. For instance, Jothinathan et al. (L. Jothinathan, Q. Q. Cai, et al., Fe—Mn doped powdered activated carbon pellet as ozone catalyst for cost-effective phenolic wastewater treatment: Mechanism studies and phenol by-products elimination, [J] Journal of Hazardous Materials, 424 (2022) 127483) prepared a novel bimetallic doped polyaluminium chloride (Fe—Mn/PAC) particle in a sol-gel method and used it as an ozone catalyst for treating phenolic wastewater (PWW). By using the Fe—Mn/PAC particle microbubble ozone oxidation technology, the chemical oxygen demand (COD) and the removal rate of phenol in PWW increased to 79% and 95% in 1 hour, respectively; moreover, Fe—Mn/PAC does not have the ability to adsorb ozone. In the research by Yewen Qiu (Y. Qiu, X. Xu, Z. Xu, J. Liang, Y. Yu, X. Cao, Contribution of different iron species in the iron-biochar composites to sorption and degradation of two dyes with varying properties, [J] Chemical Engineering Journal, 389 (2020)), iron-biochar composites exhibited greater dye removal capacity as compared with raw biochar, and the removal efficiencies of methylene blue and acid orange 7 increased from 33%-72% to 48%-92% and from 49%-70% to 72%-85%, respectively. This shows that the iron-biochar composites can effectively remove dyes, and iron species play an important role in dye removal. However, iron exists in such a single form that iron oxides predominate, which leads to poor stress resistance in practical applications.

For another instance, Chinese patent CN202211167489 discloses a chitosan-based biochar with porous structure and high specific surface area as well as a preparation method and application thereof, wherein chitosan is dispersed in a solvent mixture of potassium hydroxide, urea, and water, followed by freeze-drying and calcining to obtain a catalyst applied in the field of persulfate. Chinese patent CN202111060989 discloses a high-elasticity high-temperature-resistant aerogel and a preparation method thereof, wherein modified biochar undergoes steps such as low-temperature baking, microwave heating with carbon dioxide, ultrasonic treatment, electrostatic directional freeze-drying, and vacuum sublimation to produce an aerogel with a porous three-dimensional network structure, which endows the aerogel with properties of oil absorption and high elasticity.

The above patent applications demonstrate the excellent performance of aerogels in other fields, but these catalysts cannot be effectively supportive of catalyzing ozone. Ozone, as one of advanced oxidation processes that are most promising in practical engineering applications, tends to decompose into oxygen in water since it exists in the form of gas, which reduces the utilization ratio thereof. Therefore, one of the main focuses of ozone process research is the synthesis of a high-quality ozone catalyst, which can reduce costs and address actual problems in a green and efficient manner while increasing the ozone utilization ratio.

### SUMMARY

### 1. Technical Problem to be Solved by the Invention

It is the first objective of the present invention to provide a polycrystalline-iron-loaded porous biochar aerogel catalyst. The biochar aerogel has a pore-rich structure, which can provide an abundance of adsorption-active and reaction-active sites, as well as electron transfer pathways, so that it can effectively enhance the catalytic efficiency of the catalyst. In the catalyst, polycrystalline iron nanoparticles are stably loaded on the surface of the porous biochar through Fe—C bonds, which can significantly improve the mechanical strength and structural stability of the catalyst.

It is the second objective of the present invention to provide a preparation method of the above polycrystalline-iron-loaded porous biochar aerogel catalyst. Moreover, the preparation process is simple in operation and relatively low in production costs.

It is the third objective of the present invention to provide application of the above polycrystalline-iron-loaded porous biochar aerogel catalyst to water purification, air purification, chemical catalysis, and energy storage. Especially, when applied in an ozone catalytic purification system, it can adsorb ozone to form surface atomic oxygen, so that it can stably and efficiently play a role in electron transfer during the treatment of emerging pollutants in tail water.

### 2. Technical Solutions

To achieve the above objectives, the technical solutions provided in the present invention are put as follows.

In a first aspect, the present invention provides a polycrystalline-iron-loaded porous biochar aerogel catalyst, which has an internal structure that is an overall honeycomb-like pore network structure, and comprises a porous biochar substrate, with polycrystalline iron nanoparticles loaded on biochar layers through Fe—C bonds.

The catalyst in the present invention has a porous biochar substrate as a carrier. The biochar substrate has a layered structure. The layers crosslink with each other to form a network structure, and honeycomb-like pore channels are distributed on the biochar layers. As such, the structure is relatively rich in pores, greatly increasing the specific surface area of the catalyst. Therefore, when applied to water purification treatment, it can provide more adsorption-active and reaction-active sites and more electron transfer pathways for the adsorption and degradation of organic matters such as antibiotics, so that it can effectively improve the degradation efficiency of organic matters such as antibiotics. Meanwhile, in the present invention, polycrystalline iron nanoparticles are uniformly loaded on the biochar layers, and the presence of polycrystalline iron can provide more active sites, which is conductive to improving and ensuring the catalytic effect of the catalyst. Moreover, as the polycrystalline iron nanoparticles are loaded on the biochar layers through Fe—C bonds, the loading firmness thereof on the catalyst can be effectively improved, which is conductive to enhancing the mechanical strength of the entire catalyst and the stability of the catalyst, and compensating for the defect of insecure compounding on the surfaces of iron-based materials and carbon-based materials in the prior art.

It should be noted that with regards to loading the polycrystalline iron nanoparticles on the biochar layers through the Fe—C bonds in the present invention, they can be directly loaded on the biochar layers, or indirectly loaded thereon, that is, the load connection between the polycrystalline iron nanoparticles and the biochar layers is realized through crosslinking agents. In addition, the macro-shape of the polycrystalline-iron-loaded porous biochar aerogel in the present invention is not limited and can be changed according to actual situations and needs. For example, it can be a cylindrical structure (with interconnected pores inside), such as sphere, square, column, and block; it can also be an irregular shape; alternatively, it can also be a thin-film shape.

As a further improvement to any technical solution of the catalyst in the first aspect of the present invention, the polycrystalline iron has a crystal plane that includes, but is not limited to, (220) crystal plane of Fe₃O₄, (002) crystal plane of Fe₃C, (211) crystal plane of Fe₃C, and (031) crystal plane of Fe₂O₃.

As a further improvement to any technical solution of the catalyst in the first aspect of the present invention, different crystals of the polycrystalline iron alternately grow inside the biochar layers, and interlaced reticular lattice fringes are visible under a transmission electron microscope, so that more active sites can be provided for ozone catalysis.

As a further improvement to any technical solution of the catalyst in the first aspect of the present invention, the polycrystalline iron has a content of 0.27 at % to 37 at % of the total amount of the catalyst, wherein Fe(III) accounts for 38 at % to 54 at % of the total iron content, Fe(II) accounts for 17 at % to 31 at % of the total iron content, and Fe₃C comprises 17 at % to 31 at % of the total iron content.

As a further improvement to any technical solution of the catalyst in the first aspect of the present invention, the polycrystalline iron nanoparticles have a loading amount of 5% to 15% of catalyst mass, further preferably 10%.

As a further improvement to any technical solution of the catalyst in the first aspect of the present invention, the polycrystalline iron nanoparticles have a particle size of 1 nm to 10 nm, further preferably 5 nm to 10 nm; the polycrystalline iron nanoparticles are small in size and uniform in distribution, which is conducive to further enhancing the catalytic effect of the catalyst.

As a further improvement to any technical solution of the catalyst in the first aspect of the present invention, pores on the biochar substrate have a diameter of 50 μm to 100 μm, further preferably 70 μm to 90 μm.

As a further improvement to any technical solution of the catalyst in the first aspect of the present invention, the biochar aerogel has a contact angle less than 88°, as well as relatively good hydrophilicity, which is conducive to promoting adsorption, migration, transmission, and degradation of organic pollutants inside the catalyst.

As a further improvement to any technical solution of the catalyst in the first aspect of the present invention, the biochar aerogel has an impedance value below 11Ω, and has fast electron transfer capability.

As a further improvement to any technical solution of the catalyst in the first aspect of the present invention, the biochar aerogel has an ID/IG value greater than 0.85 in Raman spectrum, and new peaks appear at positions 877.74 cm⁻¹, 935.76 cm⁻¹, and 1004.97 cm⁻¹ in in situ Raman spectrum thereof after contact with O₃ in water. After the catalyst in the present invention comes into contact with O₃, new peaks appear at positions 877.74 cm⁻¹, 935.76 cm⁻¹, and 1004.97 cm⁻¹ in in situ Raman spectrum thereof, corresponding to surface atomic oxygen (O₂*, O*) and surface-adsorbed O₃, respectively. The main reason is that O* and O₂* can be formed after ozone is adsorbed on the surface of the material, and O₂* is further transformed into singlet oxygen through electron transfer.

Raman spectrum is used to characterize structural features of carbon material catalysts, wherein the intensity ratio (ID/IG) of wave band D to wave band G can be used to analyze the defect degree of the catalyst. The closer to 1 the ID/IG value, the higher disorder level of the biochar layers. Wrinkles, bumps, and defects on the biochar layers not only can generate the redox activity, but also can serve as electron transfer media and reaction-active sites.

In a second aspect, the present invention provides a preparation method of the polycrystalline iron-loaded porous biochar aerogel catalyst as described in the first aspect of the present invention, comprising:
contacting/mixing iron-based biochar with a crosslinking agent in an aqueous solution to form an iron-based-biochar-crosslinking-agent mixture (i.e., iron-based biochar hydrogel); wherein the iron-based biochar comprises a biochar substrate and polycrystalline iron nanoparticles loaded on biochar layers, and at this moment, physical combination is present between the polycrystalline iron nanoparticles and the biochar substrate;
applying freeze-drying treatment to the iron-based-biochar-crosslinking-agent mixture to form honeycomb-like voids in the biochar layers, thereby obtaining iron-based biochar aerogel; wherein the iron-based-biochar-crosslinking-agent mixture is first frozen into ice by the freeze-drying treatment, and then pores are formed in the biochar layers by sublimation;
calcining the iron-based biochar aerogel in an inert atmosphere to load the polycrystalline iron nanoparticles on the biochar layers through Fe—C bonds, thereby obtaining the polycrystalline iron-loaded porous biochar aerogel catalyst.

The present invention makes use of the ionic exchange effect of the crosslinking agent to crosslink the iron base with the biochar layers. The overall preparation process is simple. The porous biochar aerogel is tightly combined in the form of iron-carbon and has a certain mechanical strength, and can adsorb ozone to form surface atomic oxygen, so that it stably and efficiently plays a role of electron transfer during the treatment of emerging pollutants in tail water, and improves the ozone catalytic efficiency. Additionally, the raw materials used for preparation in the present application are green, non-polluting, readily available, low in cost, easy to produce on a large scale, and applicable in such fields as environmental organic-polluted water treatment and deep purification treatment of drinking water.

The aerogel obtained directly by freeze-drying is relatively unstable. The low-temperature calcination helps firmly load polycrystalline iron on the porous biochar substrate. The fusion of two types of carbon is beneficial to ensuring the structural stability and preventing collapse. Specifically, the crosslinking agent binds to polycrystalline iron through Fe—C bonds, while biochar binds to the crosslinking agent mainly through C═C/C—C bonds.

As a further improvement to any technical solution of the preparation method in the second aspect of the present invention, the iron-based biochar (polycrystalline iron biochar) has a specific surface area of 150 m²/g to 250 m²/g, so that it can provide an abundance of active sites for adsorption and degradation of antibiotic organic pollutants, which is beneficial to enhancing the catalytic activity of the catalyst.

As a further improvement to any technical solution of the preparation method in the second aspect of the present invention, the crosslinking agent includes, but is not limited to, chitosan, carrageenan, and sodium alginate, wherein the mass ratio of the iron-based biochar to the crosslinking agent is (2-5): (1-5), further preferably (2-5): 3.

Further, the crosslinking agent is preferably chitosan. Since chitosan contains a relatively large amount of element N, using it as the crosslinking agent not only can realize the firm loading of the polycrystalline iron nanoparticles, but also can provide a nitrogen source to realize the doping of the element N onto the catalyst. While co-doping ensures the catalytic stability of the catalyst, the synergistic effect of the two promotes the adsorption and catalytic degradation of antibiotic organic pollutants, resulting in better catalytic performance than carbon materials doped with a single element.

As a further improvement to any technical solution of the preparation method in the second aspect of the present invention, the biochar includes, but is not limited to, bamboo charcoal, straw biochar, and coconut shell charcoal, further preferably bamboo charcoal. Bamboo charcoal not only is green and non-polluting in raw materials, readily available, and low in cost, but also possesses a relatively large specific surface area, which can provide an abundance of active sites for adsorption and degradation of antibiotic organic pollutants, and are conducive to further enhancing the catalytic activity of the catalyst.

As a further improvement to any technical solution of the preparation method in the second aspect of the present invention, organic acid or inorganic acid is added to the aqueous solution to adjust the consistency of the solution, thereby obtaining viscous hydrogel; the organic acid or inorganic acid can be, e.g., hydrochloric acid, formic acid, acetic acid, lactic acid, malic acid, or ascorbic acid, preferably acetic acid, and the ratio of the iron-based biochar, the crosslinking agent, the acetic acid, and water is (0.8 g to 2 g): (0.8 g to 2 g): (0.4 ml to 0.8 ml): (38 ml to 35.2 ml), and preferably 1.6 g: 1.2 g: 0.8 ml: 36.4 ml.

As a further improvement to any technical solution of the preparation method in the second aspect of the present invention, said applying freeze-drying treatment to the iron-based-biochar-crosslinking-agent mixture comprises: first freezing the iron-based-biochar-crosslinking-agent mixture at −15° C. to −25° C., and then freeze-drying at −70° C. to −85° C., so as to form pores.

As a further improvement to any technical solution of the preparation method in the second aspect of the present invention, said calcining the iron-based biochar aerogel in an inert atmosphere comprises: heating the iron-based biochar aerogel to a temperature of 100° C. to 200° C. at a rate of 1° C./min to 8° C./min, maintaining the temperature for 1.0 h to 2.0 h, and then cooling to room temperature. The inert atmosphere is high-purity nitrogen or argon with a purity of ≥99.99%.

As a further solution based on any technical solution of the preparation method in the second aspect of the present invention, the iron-based biochar is prepared in a chemical deposition method or a mechanical ball milling method.

As a manner of implementation of any technical solution of the preparation method in the second aspect of the present invention, the preparation process of the iron-based biochar specifically comprises:
mixing and dispersing an iron source and biochar in ultrapure water, removing supernatant after mixing at room temperature for a certain period, and then drying, cooling, and grinding to obtain an iron salt composite biochar material, i.e., the iron salt binds onto the surface of the biochar through electrostatic complexation.
applying high-temperature calcination to the iron salt composite biochar material under conditions of air exclusion, followed by cooling and grinding treatment, thereby obtaining the iron-based biochar material; after calcination, the iron salt undergoes high-temperature decomposition, and polycrystalline iron is loaded onto the biochar layers.

Further, the iron source is one or more of iron nitrate, iron chloride, or iron citrate.

Further, said applying high-temperature calcination to the iron salt composite biochar material under conditions of air exclusion comprises: heating to a temperature of 300° C. to 800° C. at a rate of 1° C./min to 5° C./min, then maintaining the temperature for 1 h to 4 h; preferably, heating to a temperature of 700° C. at a rate of 3° C./min and maintaining the temperature for 3 h. Preferably, the inert atmosphere is high-purity nitrogen or argon with a purity of ≥99.99%.

Further, it further comprises: acid-washing the iron-based biochar material synthesized through the high-temperature calcination, then washing with ultrapure water to achieve a neutral pH, so as to remove loosely bound iron and prevent dissolution of iron during subsequent use. Further, sulfuric acid is preferably used for acid washing, and sulfuric acid preferably has a concentration of 1 mol/L.

In a third aspect, the present invention further provides application of any porous biochar aerogel catalyst as described in the first aspect in fields of water purification, air purification, or chemical catalysis.

Further, the water purification system includes, but is not limited to, an ozone catalytic oxidation system, and has a usage method, comprising:

in the ozone catalytic oxidation system, bringing the porous biochar aerogel catalyst into contact with ozone in water to be treated to form surface atomic oxygen, catalyzing the decomposition of ozone to produce singlet oxygen and hydroxyl radicals, thereby enhancing the degradation of pollutants or antibiotics in the water.

Further, the water to be treated includes both hard-to-degrade high-concentration antibiotic pharmaceutical wastewater and low-concentration effluent from sewage-treatment plants, wherein the hard-to-degrade high-concentration antibiotic pharmaceutical wastewater has an antibiotic concentration of 1 mg/L to 100 mg/L, and the low-concentration effluent from sewage-treatment plants has an antibiotic concentration of 1 μg/L to 20 μg/L.

### 3. Beneficial Effects

In summary, the technical solutions provided in the present invention can achieve the following beneficial effects as compared with the prior art.
(1) The present invention provides a polycrystalline-iron-loaded porous biochar aerogel. The aerogel comprises a porous biochar substrate and polycrystalline iron nanoparticles loaded onto the substrate. It has an abundance of pores and a relatively large specific surface area, and can adsorb ozone to form surface atomic oxygen, so that it can stably and efficiently play a role of electron transfer in the treatment of emerging pollutants in tail water. Meanwhile, it provides an abundance of active sites for adsorption and degradation of antibiotic organic pollutants, and therefore can enhance the catalytic efficiency of ozone. Moreover, the polycrystalline iron nanoparticles are uniformly loaded on the biochar layers through Fe—C bonds. On one hand, the presence of various iron-containing crystals helps provide more reaction-active sites. On the other hand, the polycrystalline iron nanoparticles are loaded through in the form of Fe—C bonds, rather than simply through physical combination, which ensures not only the stable loading of polycrystalline iron but also the stability of the pore structure in the aerogel. Additionally, the synergistic effect between the two enhances the catalytic activation of ozone and the degradation and removal of antibiotic pollutants.
(2) The polycrystalline iron nanoparticles in the present invention have a particle size of 1 nm to 10 nm, which is so small to further improve the catalytic decomposition effect of ozone. In addition, as compared with porous biochar aerogel materials without loading polycrystalline iron, the polycrystalline-iron-loaded porous biochar aerogel has a pore-richer structure, which provides an abundance of adsorption-active and reaction-active sites for adsorption and degradation of antibiotic organic pollutants, as well as electronic transfer pathways, and are therefore conducive to improving the degradation efficiency of organic matters such as antibiotics.
(3) Compared with other carbon aerogel materials, the polycrystalline-iron-loaded porous biochar aerogel in the present invention exhibits relatively good hydrophilicity, which is beneficial to further improving the adsorption, migration, transfer, and degradation of organic pollutants inside the catalyst. With an impedance value below 11Ω, it has fast electron transfer capability. At the same time, the catalyst has good elasticity and does not deform after multiple stages of compression. Since it has a relatively high ID/IG value, the material is rich in defects, which is beneficial to rapid adsorption and conversion of pollutants and oxidants inside the material.
(4) When the polycrystalline-iron-loaded porous biochar aerogel is prepared in the present invention, a crosslinking agent in a certain amount is added. Under the action of the crosslinking agent, the polycrystalline iron nanoparticles can be loaded on the biochar layers in the form of Fe—C bonds by calcination, which is beneficial to improving the stability of the loading of the polycrystalline iron nanoparticles and the pore structure. Further, the crosslinking agent is preferably chitosan, which can also serve as a nitrogen source, so that the element N is uniformly loaded on the aerogel. Through the co-doping of carbon and nitrogen, the adsorption and catalytic degradation of antibiotic organic pollutants are promoted.
(5) The present invention is simple in preparation process, low in cost, and suitable for large-scale promotion and application, and the prepared aerogel can be processed into various shapes according to needs, such as cylinder, sphere, square, column, block, irregular shapes, and thin-film shapes.
(6) The aerogel catalyst in the present invention can be applied to water purification, air purification, chemical catalysis, or energy storage. When applied to water purification, it can be applied to, but is not limited to, an ozone catalytic oxidation system. Moreover, it can be used for purification treatment of both hard-to-degrade high-concentration antibiotic pharmaceutical wastewater and low-concentration effluent from sewage-treatment plants.

### BRIEF DESCRIPTION OF DRAWINGS

In FIG. 1, (a) is an SEM image of the aerogel prepared in Example 4, (b) is an SEM image of the aerogel obtained in Comparative Example 1, and (c), (d), (e), and (f) are TEM images of the aerogel obtained in Example 4;

FIG. 2 is SEM images of the aerogels obtained in Comparative Example 2 and Examples 2, 3, and 5;

FIG. 3 is an SEM energy spectrum analysis image of the aerogel prepared in Example 4;

in FIG. 4, (a) and (b) are pressure test results of the aerogels prepared in Example 4 and Comparative Example 1, respectively; (c) to (h) are contact angles of the aerogels in Comparative Example 1, Comparative Example 2, and Examples 2-5, respectively;

FIG. 5 is a XPS full spectrum image of the aerogels obtained in Examples 2-5; in FIG. 6, (a) is Raman spectrum of the aerogels obtained in Examples 2-5, and (b) is in situ Raman spectrum of Example 4;

FIG. 7 is an impedance diagram of the aerogels obtained in Comparative Example 1 and Example 4;

in FIG. 8, (a) is a ratio diagram of different carbon in the aerogels obtained in Examples 2-5, (b) is a ratio diagram of different nitrogen in the aerogels obtained in Examples 2-5, (c) is a ratio diagram of different oxygen in the aerogels obtained in Examples 2-5, and (d) is a ratio diagram of different iron in the aerogels obtained in Examples 2-5;

FIG. 9 shows the relationship between components at different ratios in the aerogels obtained in Examples 2-5 and the catalytic efficiency;

in FIG. 10, (a) shows kinetic curves of the catalytic degradation of levofloxacin by different aerogels, and (b) shows kinetic fittings of the catalytic degradation of levofloxacin by different aerogels;

in FIG. 11, (a) is free radical quenching experiment results of levofloxacin degraded by the aerogel in Example 4, (b) is an EPR spectrum of singlet oxygen in the course of degrading levofloxacin by the aerogel in Example 4, (c) is an EPR spectrum of hydroxyl radicals in the course of degrading levofloxacin by the aerogel in Example 4, and (d) is an EPR spectrum of superoxide ion radicals in the course of degrading levofloxacin by the aerogel in Example 4;

FIG. 12 shows results of recycling experiments that the aerogel catalyzes ozone to degrade levofloxacin in Example 4;

FIG. 13 shows results of experiments that the aerogel catalyzes ozone to degrade antibiotics in tail water in Example 4.

### DESCRIPTION OF EMBODIMENTS

The present invention provides a polycrystalline-iron-loaded porous biochar aerogel catalyst, which comprises a porous biochar substrate and polycrystalline iron nanoparticles uniformly distributed on the biochar substrate. The porous biochar substrate and the polycrystalline iron nanoparticles together form a polycrystalline iron biochar material, wherein the catalyst has a honeycomb-like pore network structure as a whole (that is, the biochar layers are cross-linked with each other to form a three-dimensional network structure, and there are interconnected pores inside), with a pore-rich structure and a relatively large specific surface area, so that it can adsorb ozone to form surface atomic oxygen, and provide an abundance of active sites for adsorption and degradation of organic pollutants such as antibiotics, and is therefore conducive to improving the degradation efficiency of organic matters such as antibiotics. The polycrystalline iron nanoparticles are uniformly loaded on the biochar layers through Fe—C bonds, which not only can promote the adsorption and catalytic degradation of organic pollutants such as antibiotics, further improve the catalytic efficiency, but also can effectively ensure the loading firmness of the polycrystalline iron nanoparticles, which is conducive to improving the overall mechanical strength of the catalyst and further ensuring the catalytic stability of the catalyst.

As a further preferred solution of the polycrystalline-iron-loaded porous biochar aerogel catalyst in the present invention, the polycrystalline iron biochar material has a specific surface area of 150 m²/g to 250 m²/g, pores on the biochar substrate have a diameter of 50 μm to 100 μm, further preferably 70 μm to 90 μm. In some examples, the polycrystalline iron nanoparticles have a size (particle size) of 1 nm to 10 nm, further preferably 5 nm to 10 nm.

The polycrystalline iron has a crystal plane that includes, but is not limited to, (220) crystal plane of Fe₃O₄, (002) crystal plane of Fe₃C, (211) crystal plane of Fe₃C, and (031) crystal plane of Fe₂O₃. As a further preferred solution of the polycrystalline-iron-loaded porous biochar aerogel catalyst in the present invention, the polycrystalline iron nanoparticles have a loading amount of 5% to 15% of the mass of the catalyst, or the polycrystalline iron has a content of 0.27 at % to 37 at % of the total amount of the catalyst, wherein Fe(III) accounts for 38 at % to 54 at % of the total iron content, Fe(II) accounts for 17 at % to 31 at % of the total iron content, and Fe₃C comprises 17 at % to 31 at % of the total iron content.

To further understand the content of the present invention, a detailed description of the present invention will be provided in combination with specific examples. The devices and instruments used in the experimental course of each example are shown in Table 1-1 as follows.

TABLE 1-1
List of Instruments

| | Specifications and | |
|---|---|---|
| Names of Instruments | Models | Manufacturers |
| Liquid Chromatograph- | TripleTOF5600 | SCIEX Corporation, USA |
| Mass Spectrometer | | |
| Ultraviolet And Visible | UV-1900 | Shimadzu Instruments (Suzhou) Co., Ltd. |
| Spectrophotometer | | |
| Fourier-Transform Infrared | NicoletiN10MX | Thermo Fisher Scientific Inc., USA |
| Microspectrometer | | |
| High-Resolution Raman | 220 nm-2200 nm | HORIBA |
| Spectrometer | | |
| High-Performance Liquid | Waters2695 | Waters Corporation, USA |
| Chromatograph | | |
| Contact Angle Meter | OCA25 | DIFU Instruments Co., Ltd. |
| Atomic Absorption | AA-7000F/G | Shimadzu Corporation, Japan |
| Spectrophotometer | | |
| Paramagnetic Resonance | EMXplus-6/1 | Bruker Corporation, Germany |
| Spectrometer | | |
| X-Ray Photoelectron | Scientific K-Alpha | Thermo, USA |
| Spectrometer | | |
| Transmission Electron | JEM-F200 | JEOL, Japan |
| Microscopy Analysis | | |
| X-ray Diffraction Analysis | D8ADVANCE | Bruker, Germany |
| Scanning Electron | Sigma 300 | ZEISS, Germany |
| Microscopy Analysis | | |

Some detection experiments and operation instructions thereof involved in the examples of the present invention are put as follows.

### 1. Transmission Electron Microscopy (TEM) Analysis

In the present invention, after the evenly ground aerogel powder passed through a 100-mesh sieve, it was dispersed into an ethanol solution, and is ultrasonically rendered invisible to naked eyes; a processed sample was taken and dropped onto a copper mesh grid, then irradiated with an infrared lamp to rapidly evaporate the ethanol solution, so that the tested sample was dried. In this experiment, the layered structure on the surface of the biochar aerogel and the nanoparticles of the transition metal iron inside the aerogel were observed under different magnifications, and the crystal structure of iron was identified by observing crystal diffraction rings formed by polycrystalline iron and lattice fringes of iron metal nanoparticles.

### 2. X-Ray Diffraction (XRD) Analysis

The X-ray diffraction analysis in the present invention used a Cu target, and was arranged to have an angle of 20° to 80° and a scanning speed of 10°/min. CS, Fe-BC, 4BC/3CS, 2Fe-BC/3CS, 3Fe-BC/3CS, 4Fe-BC/3CS, and 5Fe-BC/3CS materials were compressed into uniform thin slices by using a small tablet press before conducting the test.

### 3. Microscopic Infrared Spectroscopy (Micro FTIR)

Through microscopic infrared spectroscopy, qualitative analysis of functional groups and chemical structures inside the catalyst was carried out and semi-quantitative analysis of chemical element types and substance purity was performed. In the present invention, CS, 4BC/3CS, 2Fe-BC/3CS, 3Fe-BC/3CS, 4Fe-BC/3CS, and 5Fe-BC/3CS materials were uniformly compressed by using a small tablet press and then cut into small pieces for observation.

### 4. X-Ray Photoelectron Spectroscopy (XPS) Analysis

In the present invention, 4BC/3CS, 2Fe-BC/3CS, 3Fe-BC/3CS, 4Fe-BC/3CS, and 5Fe-BC/3CS materials were uniformly pressed by using a small tablet press and then cut into small pieces for observation, and the effect of different additive amounts of powdered biochar on the ratio of the elements C, N, O, and Fe in the aerogel material was analyzed.

### 5. Impedance Analysis (EIS)

Electrochemical impedance spectroscopy studies the relationship between AC impedance and frequency by applying a small-amplitude sinusoidal AC excitation signal to an electrochemical cell in equilibrium or under stable DC polarization conditions. By analyzing the impedance value (EIS) of the catalyst, the electron transfer capability thereof can be reflected. 5 mg of aerogel catalyst powder, 400 μL of ultrapure water, 400 μL of ethanol, and 5 μL of Nafion were mixed, and then subjected to ultrasonic treatment for 30 min to obtain a corresponding dispersion; then, 200 μL of suspension was dropped onto FTO conductive glass (1.5 cm×1.5 cm) and baked dry under irradiation of an infrared lamp. A three-electrode system (counter electrode: platinum electrode; reference electrode: Ag/AgCl; working electrode: FTO) was used, and the electrolyte solution was a 0.5 mol/L Na₂SO₄ solution.

6. In situ Raman (IS Raman) Analysis

In situ Raman is to characterize ongoing reactions by using a high-resolution laser Raman spectroscopy, which includes two parts: an in-situ electrochemical Raman cell and a Raman spectroscopy analyzer. Before the experiment, a 532 nm green laser was vertically aimed at the side face of a dual-channel quartz cuvette (7.5 mm×12.5 mm×45 mm, volume: 1.75 mL) to let the laser pass through the cuvette. At the beginning of the experiment, a certain amount of aerogel catalyst was added into the quartz cuvette, and an aqueous solution of ozone was added through a syringe. Then, the quartz cuvette was sealed with a lid, and shaken gently to ensure uniform suspension of the solid catalyst. After sufficient reaction, the Raman laser device was started, with a scanning range from 200 cm⁻¹ to 1200 cm⁻¹ and a resolution of 2 cm⁻¹. In the experiment, the laser irradiation did not lead to ozone decomposition. For the sake of comparison, ultrapure water and a water solution saturated with oxygen were added to replace the water solution of ozone in the same procedures.

### 7. Electron Paramagnetic Resonance (EPR)

EPR is a magnetic resonance technique based on the magnetic moment of unpaired electrons, which can be used to qualitatively and quantitatively detect unpaired electrons in substances, and further study the structural properties of materials. At the beginning of the reaction, unsaturated diamagnetic functional groups (such as 5,5-dimethyl-1-pyrroline-N-oxide) were added to the reaction system, and the ·OH generated by the system was detected through the EPR spectroscopy in combination with specific peak shapes of free radicals, leaving a peak shape of 1:2:2:1. In this experiment, EPR was used to capture ¹O₂, ·OH, and ·O₂⁻ with TEMP (2,2,6,6-tetramethyl-4-piperidone hydrochloride), DMPO (5,5-dimethyl-1-pyrroline-N-oxide), and MeOH (methanol) at 30 sec and 60 sec after the start of the degradation reaction, and detect the reactive oxygen species produced in the 4Fe-BC/4CS & O₃ system.

### Example 1

This example provides a polycrystalline-iron-loaded porous biochar aerogel catalyst. The catalyst comprises a porous biochar substrate and polycrystalline iron nanoparticles uniformly distributed on the biochar substrate. The porous biochar substrate and the polycrystalline iron nanoparticles together form a polycrystalline iron biochar material, wherein the catalyst has an overall honeycomb-like pore network structure and the polycrystalline iron nanoparticles are uniformly loaded on the biochar layers through Fe—C bonds. As compared with porous biochar aerogel materials without loading polycrystalline iron, the polycrystalline-iron-loaded porous biochar aerogel has a pore-richer structure, which provides more adsorption-active and reaction-active sites for adsorption and degradation of antibiotic organic pollutants, as well as more electronic transfer pathways.

Specifically, the macro-shape of the polycrystalline-iron-loaded porous biochar aerogel in this example is a black column (the production mold can be changed according to actual needs, so as to produce products in different shapes). The polycrystalline iron biochar material has a specific surface area of 150 m²/g to 250 m²/g, pores on the biochar substrate have a diameter of 70 μm to 90 μm, and the polycrystalline iron nanoparticles have a size (particle size) of 5 nm to 10 nm. The polycrystalline iron has a crystal plane that includes, but is not limited to, (220) crystal plane of Fe₃O₄, (002) crystal plane of Fe₃C, (211) crystal plane of Fe₃C, and (031) crystal plane of Fe₂O₃.

The polycrystalline iron nanoparticles have a loading amount of 5% to 15% of the mass of the catalyst, or the polycrystalline iron has a content of 0.27 at % to 37 at % of the total amount of the catalyst, wherein Fe(III) accounts for 38 at % to 54 at % of the total iron content, Fe(II) accounts for 17 at % to 31 at % of the total iron content, and Fe₃C comprises 17 at % to 31 at % of the total iron content.

In this example, the biochar aerogel has a contact angle less than 88° and an impedance value below 11Ω. The biochar aerogel has an ID/IG value greater than 0.85 in Raman spectrum, and new peaks appear at positions 877.74 cm⁻¹, 935.76 cm⁻¹, and 1004.97 cm⁻¹ in in situ Raman spectrum thereof after contact with O₃ in water.

### Example 2

This example provides a preparation method of a polycrystalline-iron-loaded porous biochar aerogel catalyst, comprising the following steps:
(1) using bamboo charcoal as a biochar source and weighing 5 g thereof, using ferric nitrate nine water as an iron source and weighing 160 g thereof, mixing them with 200 ml of ultrapure water after weighing, adding 10 ml of 1M nitric acid to prevent iron from hydrolysis, mixing them at room temperature for 8 h, removing the supernatant, drying overnight in an oven, grinding and passing through a 100-mesh sieve, placing and calcining in a tube furnace under protection of inert gas, heating at a rate of 3° C./min to a temperature of 700° C. in the course of calcination, and maintaining the temperature for 3.0 h, thereby obtaining a polycrystalline iron biochar material, which is recorded as Fe-BC;
(2) weighing 0.8 g of polycrystalline iron biochar, using chitosan as a nitrogen source and binder, weighing 1.2 g thereof, placing them into a beaker after weighing, adding 37.2 ml of deionized water, adding 0.8 ml of glacial acetic acid dropwise, then placing the beaker on a magnetic stirrer and stirring for 60 min, conducting ultrasonic treatment for 10 min after mixing uniformly;
(3) taking 1 ml of the sample in Step (2), adding it dropwise into a cryovial, freezing it at −20° C. in a refrigerator into a non-flowing state, then placing it into a freeze dryer, and freeze-drying it at −80° C. for 24 h;
(4) taking a certain amount of the sample in Step (3), placing the sample into a customized crucible, placing the crucible into a high-temperature tube furnace in N₂ atmosphere, heating it up to a temperature of 150° C. at a heating rate of 5° C./min, maintaining the temperature for 80 min, and then naturally cooling it down to room temperature, thereby obtaining a polycrystalline-iron-loaded porous biochar aerogel, which is recorded as 2Fe-BC/3CS.

### Example 3

While the preparation method of the polycrystalline-iron-loaded porous biochar aerogel catalyst in this example is basically the same as that in Example 2, the difference mainly lies in that in Step (2) of this example, the additive amount of polycrystalline iron biochar is 1.2 g, and the additive amount of deionized water is 36.8 ml, and the polycrystalline iron porous biochar aerogel finally prepared is recorded as 3Fe-BC/3CS.

### Example 4

While the preparation method of the polycrystalline-iron-loaded porous biochar aerogel catalyst in this example is basically the same as that in Example 2, the difference mainly lies in that in Step (2) of this example, the additive amount of polycrystalline iron biochar is 1.6 g, and the additive amount of deionized water is 36.4 ml, and the polycrystalline iron porous biochar aerogel finally prepared is recorded as 4Fe-BC/3CS.

### Example 5

While the preparation method of the polycrystalline-iron-loaded porous biochar aerogel catalyst in this example is basically the same as that in Example 2, the difference mainly lies in that in Step (2) of this example, the additive amount of polycrystalline iron biochar is 2 g, and the additive amount of deionized water is 36 ml, and the polycrystalline iron porous biochar aerogel finally prepared is recorded as 5Fe-BC/3CS.

### Comparative Example 1

(1) weighing 1.2 g of chitosan and placing it into a beaker, adding 38 ml of deionized water, adding 0.8 ml of glacial acetic acid dropwise, then placing the beaker on a magnetic stirrer and stirring for 60 min, and after mixing uniformly, conducting ultrasonic treatment for 10 min;
(2) taking 1 ml of the sample in Step (1), dropping the sample into a cryovial, freezing the cryovial in a refrigerator at −20° C. into a non-flowing state, then placing it into a freeze dryer, and freeze-drying it at −80° C. for 24 h;
(3) taking a certain amount of the sample in Step (2), placing the sample into a crucible, placing the crucible into a high-temperature tube furnace in N₂ atmosphere, heating it up to a temperature of 150° C. at a heating rate of 5° C./min, maintaining the temperature for 80 min, and then naturally cooling it down to room temperature, thereby obtaining a chitosan porous biochar aerogel, which is recorded as CS.

### Comparative Example 2

(1) weighing 1.6 g of bamboo charcoal and 1.2 g of chitosan, placing them in a beaker, adding 36.4 ml of deionized water, adding 0.8 ml of glacial acetic acid dropwise, then placing the beaker on a magnetic stirrer and stirring for 60 min, and after mixing uniformly, conducting ultrasonic treatment for 10 min;
(2) taking 1 ml of the sample in Step (1), dropping the sample into a cryovial, freezing the cryovial in a refrigerator at −20° C. into a non-flowing state, then placing it into a freeze dryer, and freeze-drying it at −80° C. for 24 h;
(3) taking a certain amount of the sample in Step (2), placing the sample into a crucible, placing the crucible into a high-temperature tube furnace in N₂ atmosphere, heating it up to a temperature of 150° C. at a heating rate of 5° C./min, maintaining the temperature for 80 min, and then naturally cooling it down to room temperature, thereby obtaining a biochar porous aerogel, which is recorded as 4BC/3CS.

### Comparative Example 3

The difference between this Comparative example and Example 4 mainly lies in that in Step (1), straw is used as a biochar source, and ferrocene is used as an iron source, so as to first prepare a ferrocene biochar material, which is recorded as Ferrocene-BC; then, chitosan is used as a nitrogen source and binder, and then freeze-dried and calcined to obtain a ferrocene biochar aerogel, which is recorded as 4 Ferrocene-BC/3CS. The other preparation procedures are basically the same as those in Example 4.

### Comparative Example 4

The difference between this Comparative example and Example 4 mainly lies in that in Step (1), straw is used as a biochar source, and ferric chloride is used as an iron source, so as to first prepare a ferric chloride biochar material, which is recorded as 4 Ferric chloride-BC; then, chitosan is used as a nitrogen source and binder, and then freeze-dried and calcined to obtain a ferric chloride biochar aerogel, which is recorded as 4 Ferric chloride-BC/3CS. The other preparation procedures are basically the same as those in Example 4.

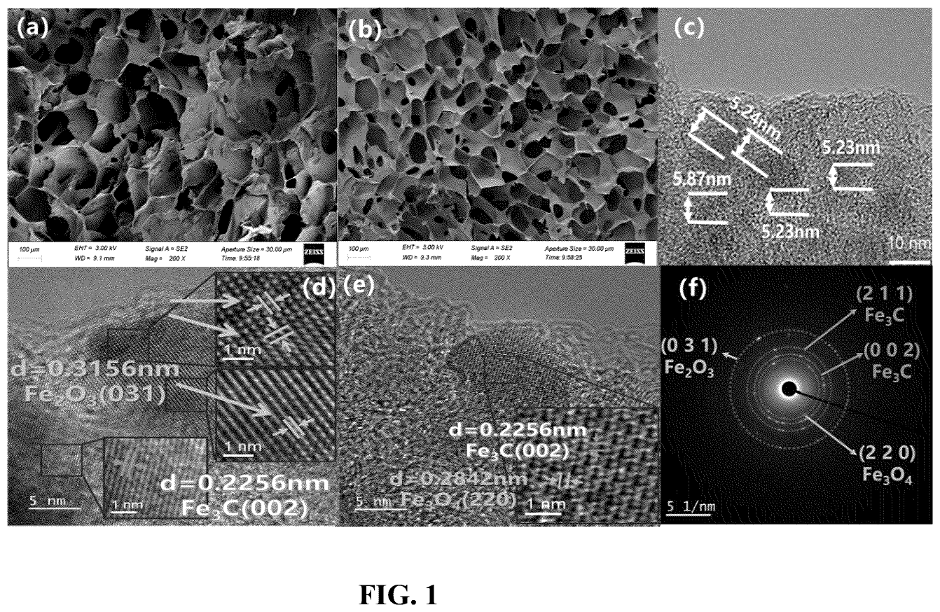

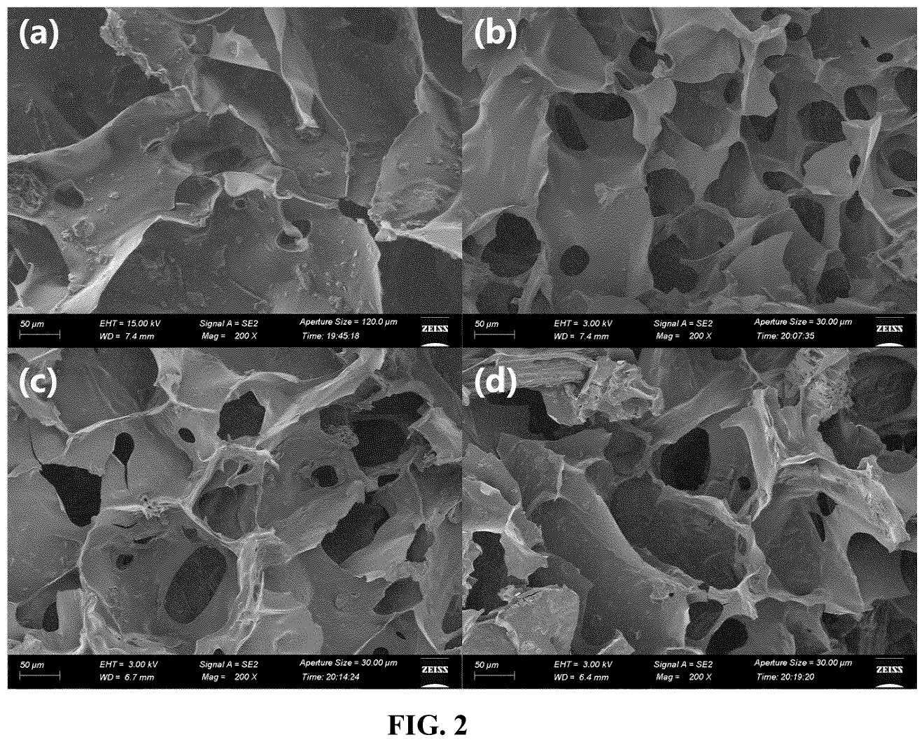

In FIG. 2, (a), (b), (c) and (d) show SEM images of the aerogels obtained in Comparative Example 2, Example 2, Example 3, and Example 5, respectively. In FIG. 1, (a) shows an SEM image of the product in Example 4. Through comparison, it is found that the biochar aerogel doped with polycrystalline iron have more uniform pores, the pores formed by directly compounding iron-free biochar with chitosan are relatively large, are pulled into uneven shapes, and are amorphous ((a) in FIG. 2). However, the pores of the biochar aerogel formed by compounding biochar, to which iron is added, with chitosan are uniform; with the increase of the additive amount of iron-based biochar, the biochar layer gradually becomes rough and the degree of defect increases.

In FIG. 1, (b) shows an SEM image of chitosan-undoped porous gas gel CS (Comparative Example 1). The low-viscosity chitosan is dispersed in an aqueous solution of acetic acid to form a colloid, and the colloid is then freeze-dried in a freeze-drying method to form a porous honeycomb-like structure with a pore size of about 80 μm. However, the CS layers are smooth and flat, have a low degree of defect, and provide a relatively small number of catalytic reaction-active sites. As chitosan is added as a cross-linking agent to the iron-based biochar material, the cross-linking effect of chitosan can be used to stably connect biochar layers to polycrystalline iron particles, so as to form a biochar porous aerogel material that is loose, porous, and stable in water. Moreover, the pore structure thereof is relatively rough, which effectively improves the electron transfer rate and provides an abundance of reaction sites for the catalytic reaction of ozone.

In FIG. 1, (c) shows a scanning image of the prepared 4Fe-BC/3CS after TEM scanning. It can be observed that the iron has particle size between 5 nm and 7 nm. Meanwhile, as shown in (d) and (e) of FIG. 1, TEM also confirms the presence of polycrystalline iron. Multiple types of crystals alternately grow inside the biochar layers, which can provide more sites for catalyzing ozone. Since multiple crystal grains exist in the material crystal and each has a different crystal plane, multiple diffraction rings appear in the diffraction pattern. As can be seen from calibration (FIG. 1f) of the diffraction rings in the region of (a) of FIG. 1, (220) crystal plane of Fe₃O₄, (002) crystal plane of Fe₃C, (211) crystal plane of Fe₃C, and (031) crystal plane of Fe₂O₃ follow the diffraction radii from inside to outside.

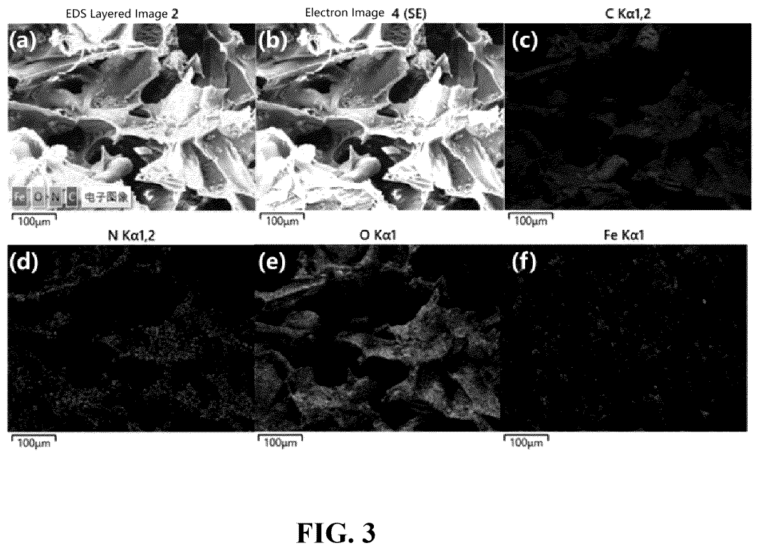

FIG. 3 shows an SEM energy spectrum analysis diagram of the aerogel in Example 4. As can be seen from d and e in FIG. 3, chitosan, as an adhesive, forms the main frame of pores; the element iron (f in FIG. 3) is evenly distributed inside the whole material, which indicates that the distribution of iron in the catalyst is uniform; as chitosan adheres to biochar, a 3D porous structure is formed. In other words, by adding a cross-linking agent, on the one hand, polycrystalline iron is firmly loaded on the porous biochar substrate through Fe—C bonds, and on the other hand, the cross-linking agent is used to bond the porous biochar layers together to form a 3D porous skeleton structure.

As shown in (a) and (b) of FIG. 4, compared with the chitosan-undoped porous aerogel CS (Comparative Example 1), the expansion ratio of the aerogel doped with polycrystalline iron biochar 4Fe-BC/3CS (Example 4) increases from 1.05 times to 1.3 times, and the original shape remains after multiple compressions, without particles peeling, which indicates that the material has relatively good softness flexibility, resilience and plasticity; moreover, the connection between the biochar layers is relatively firm. The reason may be that after biochar is doped, the material has a more stable structure through surface complexation, π-π interaction, and hydrogen bonds. At the same time, the elasticity and plasticity provide more possibilities for practical applications of the materials.

In FIG. 4, (c) to (h) show contact angle tests and absorption time of the response of the aerogels obtained in Comparative Example 1, Comparative Example 2, and Examples 2 to 5, respectively. As can be seen from the figure, the absorption time can be reduced to 0.34 s after the introduction of biochar. The reason may be that after the introduction of the biochar material, O and C functional groups, which are rich on the surface, make the material have a higher water absorption rate, but the contact angle has hardly changed) (89.8°. However, after the introduction of polycrystalline iron biochar, the contact angle and water absorption time of the composite are significantly reduced, which indicates that the hydrophilicity and water absorption performance of the aerogel are greatly improved after the introduction of iron-based biochar. The reason may be the change in the number of oxygen-containing functional groups on the surface after the iron-based biochar aerogel is subjected to heat treatment of calcination. The heat treatment can improve the hydrophilicity of the biochar material. The improvement of the hydrophilicity and water absorption rate allows pollutants to quickly react with the material inside the pores while passing through the pores inside the material, which effectively increases the exchange rate and provides conditions for the high-speed ion reaction.

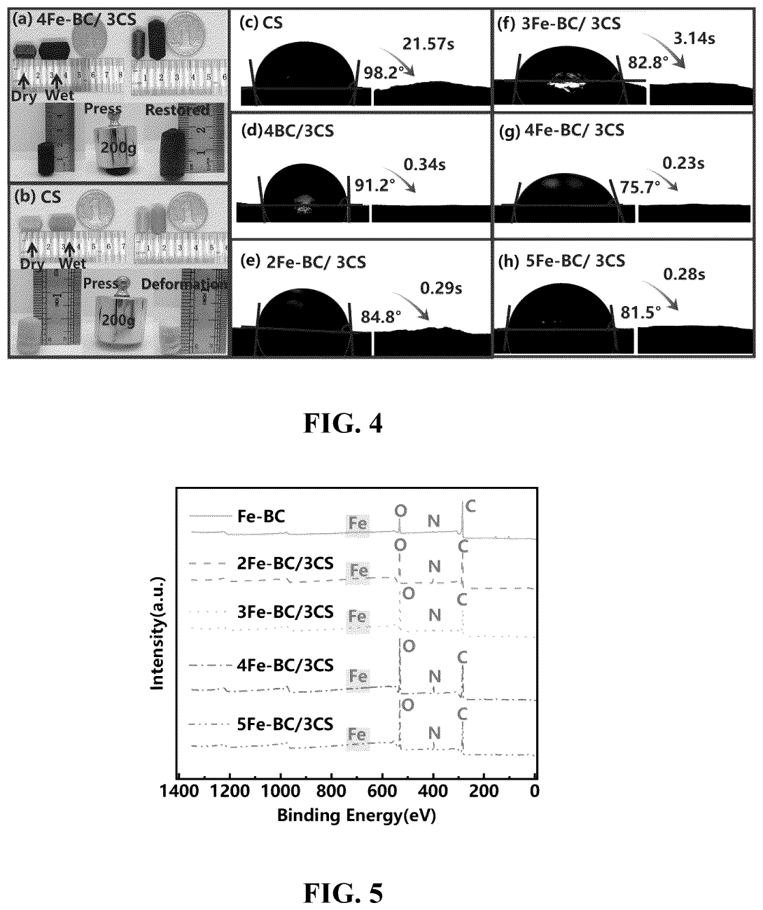

As shown in FIG. 5, there are a peak of C1s (about 283.60 eV), in the XPS full spectrum image of the aerogels obtained in Examples 2-5, a peak of N1s (about 400.00 eV), a peak of Ols (about 531.93 eV) and a peak of Fe2p (about 722.02 and 710.81 eV), and there are no peaks of other impurities. It is confirmed that Fe is successfully doped into the C skeleton, without any other products. The strength of peaks shows the content of elements in a material to some extent. An XPS spectrum image can provide a better understanding of surface constitution, chemical state, and molecular structure information of a catalyst. The XPS spectrum image with different doping ratios further demonstrates that the elements Fe, C, O, and N are the main components of Example 4. Pure biochar has an extremely low nitrogen content. After the introduction of chitosan, due to the abundant nitrogen content inside chitosan, the aggregation of nitrogen functional groups is provided, while fixing an extremely great number of reactive oxygen functional groups.

As shown in (b) of FIG. 6, Raman spectroscopy is used to characterize the structural characteristics of a carbon material catalyst. The wave band D (about 1350 cm⁻¹) and the wave band G band (about 1580 cm⁻¹) characterize the defect and crystallinity of sp3 hybrid carbon, respectively. Therefore, the intensity ratio of the wave band D to the wave band G (ID/IG) can be used to analyze the degree of defect in the catalyst. The test results in the figure indicate that the ID/IG values follow Example 4 (0.99)>Example 2 (0.951)>Example 3 (0.92)>Example 5 (0.87). The closer to 1 the ID/IG value, the higher the degree of disorder in the biochar layers. This not only can generate redox activity, but also can serve as an electron transport medium and a reaction-active site. With the increase of the additive amount of polycrystalline iron biochar, the ID/IG value first increases and then decreases, which indicates that the doping amount of iron needs to fall within an appropriate limit to maximize the catalytic effect.

In situ Raman spectroscopy further reveals the dissociation course of O₃ at an Fe site on the surface. As shown in (a) of FIG. 6, after adding O₃, new peaks appear at positions 877.74 cm⁻¹, 935.76 cm⁻¹, and 1004.97 cm⁻¹, corresponding to surface atomic oxygen (O₂*, O*) and surface-adsorbed O₃, respectively. On the contrary, this phenomenon is not observed in the suspensions, to which O₂ and ultrapure water are added. The main reason is that O* and O₂* are formed after ozone is adsorbed on the surface of the material, and O₂* is further transformed into singlet oxygen through electron transfer.

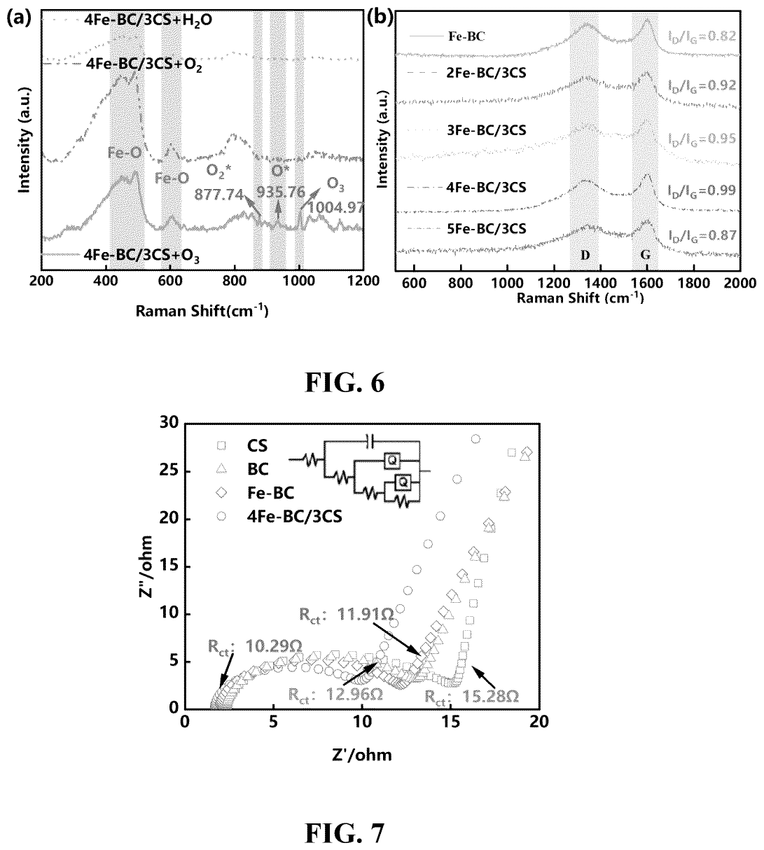

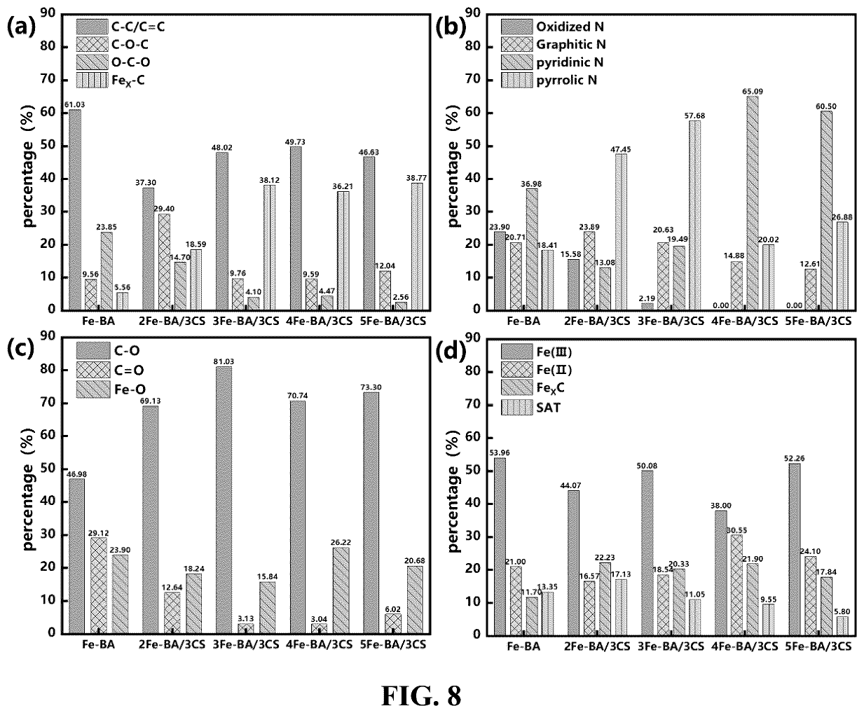

FIG. 7 is an impedance diagram of the aerogels obtained in Example 4 and Comparative Example 1 and the polycrystalline iron biochar material Fe-BC. As can be seen from the figure, the Nyquist distribution of EIS of different materials is measured in the experiment, and the diameter of the extrapolated semicircle obtained by the algorithm is taken as the accurate impedance value. Among the four materials, Rct decreases from high to low as CS (15.28Ω)>4BC/3CS (11.91Ω)>Fe BC (12.96Ω)>4Fe BC/3CS (10.29Ω). The reason may be put as follow: biochar has an excellent conductivity per se, and the conductivity is enhanced by doping metal ions iron into the biochar; after the iron-based biochar is doped into chitosan, a continuous network structure is formed, and electron transfer pathways with good conductivity are established between molecules; these pathways can provide movement paths for electrons, thereby promoting transportation and conduction of charges. As such, this is also the reason why 4Fe-BC/3CS can efficiently catalyze the degradation of organic pollutants by ozone.

As shown in FIG. 8, the nitrogen content of pure biochar is extremely low. After the introduction of chitosan, due to the abundant nitrogen content inside chitosan, the aggregation of nitrogen functional groups is provided, while fixing an extremely great number of active oxygen functional groups. The detailed diagram of N1s in (b) of FIG. 8 classifies the doped N types into pyridine N (398.2 eV), Co-Nx (399.0 eV), pyrrole N (399.9 eV), graphite N (401.1 eV), and oxidized N (402.7 eV). With the increase of the doping amount of polycrystalline iron biochar, the pyridine nitrogen content reaches 65% (Example 4). In addition, as can be seen from (d) of FIG. 8, the peak of FeX-C inside the polycrystalline iron biochar is relatively low, and FeX-C begins to increase after it is fixed on the surface of chitosan; moreover, with the increase of the doping amount of iron-based biochar, the content of FeX-C in the aerogel obtained in Example 4 is stable at about 22%, and the divalent iron reaches 31% of the total iron content. As can be seen from (a) of FIG. 8, the height of the FeX-C peak of the chitosan aerogel after freeze-drying and secondary calcination begins to increase significantly; moreover, as the additive amount of iron-based biochar rises, the height of the FeX-C peak gradually increases, reaching 36%-39%, which is not found in Fe-BC. In FIG. 8, (c) shows that the proportion of iron and oxygen remains stable at 18% to 26% under different iron-based biochar ratios, and reaches its maximum in the case of 4Fe-BC/3CS.

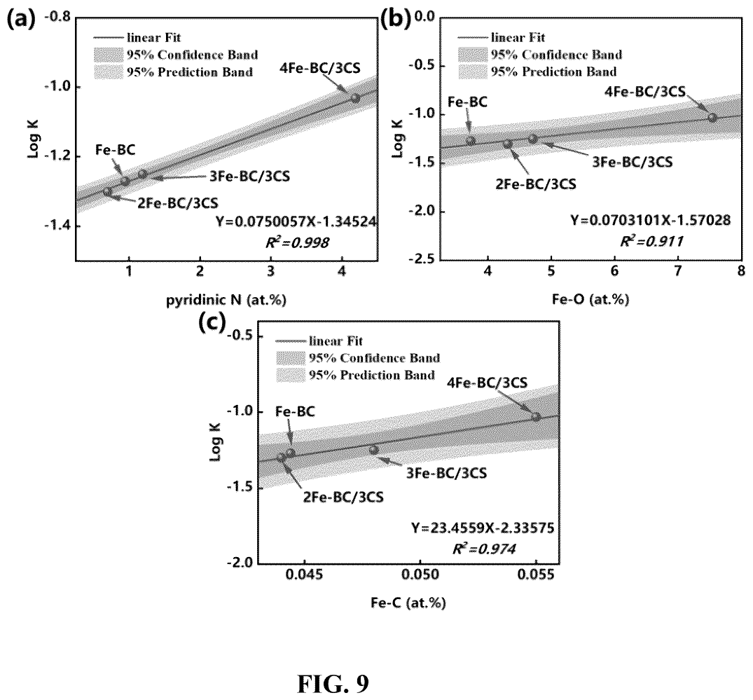

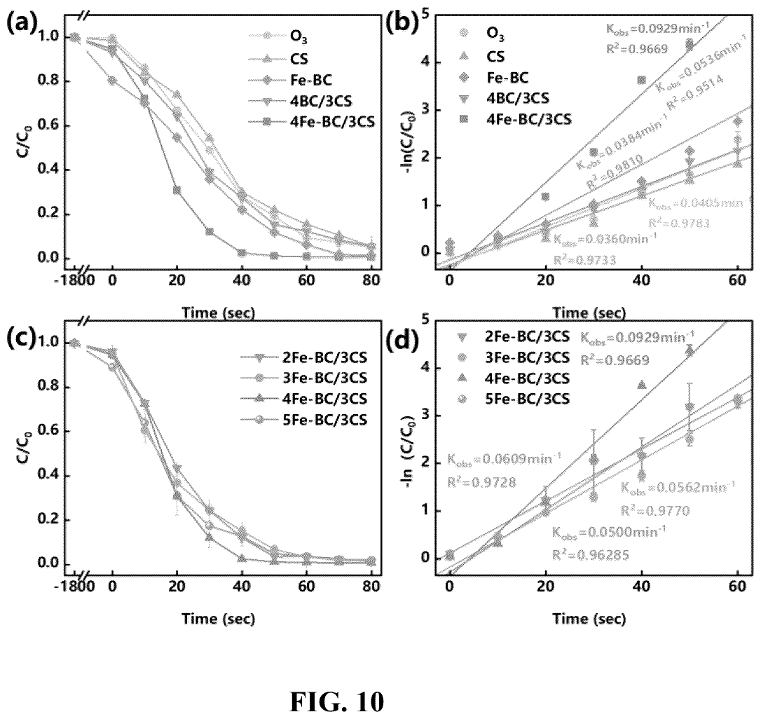

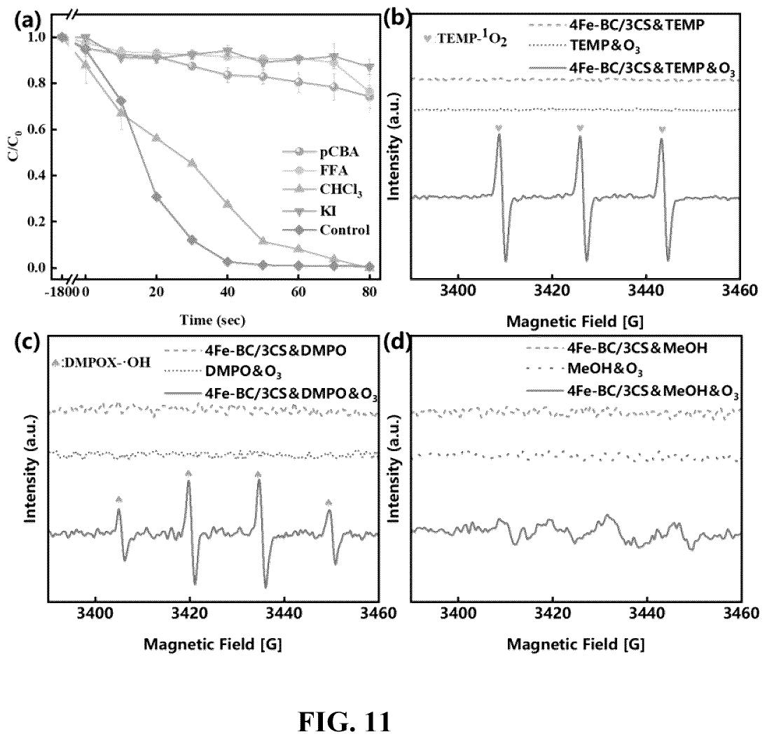

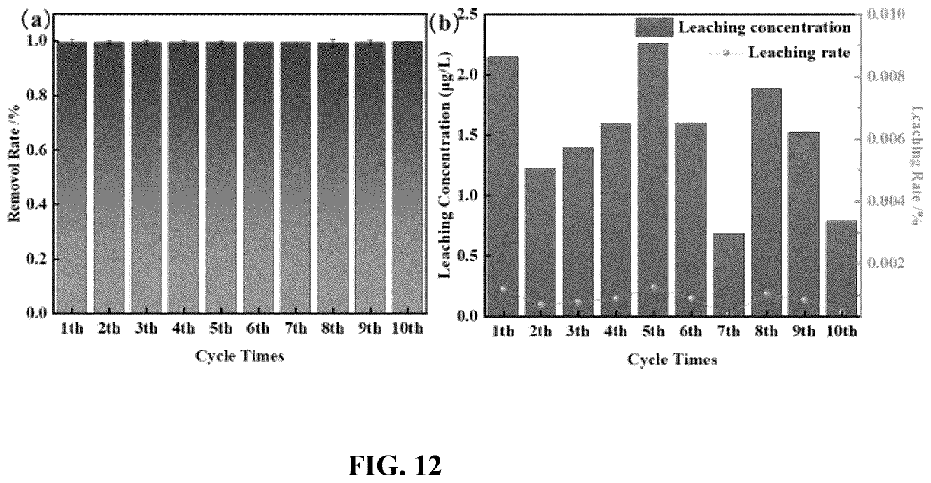

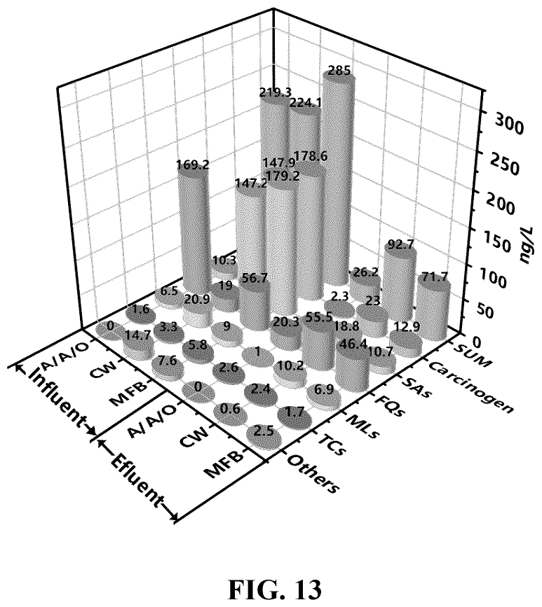

To further analyze the reasons for improving the catalytic performance, the logarithm (log (k)) of the degradation rate and the structural properties of the catalyst are fitted and analyzed (as shown in FIG. 9). The results indicate that the pyridine nitrogen content log (k) (R²=0.998) shows a good linear correlation ((a) in FIG. 9); moreover, as the pyridine nitrogen content rises, the value k increases, consistent with the experiments in the previous stage, which indicates that pyridine nitrogen is a catalytic site for ozone. In addition, there is a positive linear relationship between the Fe—C group content and log (k) (R²=0.974) ((c) in FIG. 9), which indicates that Fe—C on the catalyst can adsorb ozone well to form surface atomic oxygen, and the direct reaction between O₃ molecules and Fe₃C produces surface atomic oxygen species. The Fe—O groups on the surface of the catalyst are rich in electrons and in positively linear correlation with log (k) (R²=0.911) ((b) in FIG. 9), which drives the electron transfer pathways and promotes the formation of ¹O₂· and ·OH.

As shown in (a) of FIG. 10, the ozone activation efficiency of different systems is evaluated, and comparative experiments are conducted on multiple systems by using levofloxacin LEV as a model pollutant. In addition, the apparent rate constant K is calculated according to the established pseudo-first-order reaction kinetics ((b) in FIG. 10). The results show that Comparative Example 1 has no ability to adsorb or remove LEV; after the introduction of biochar, the adsorption capacity of aerogel in Comparative Example 2 is improved, but it cannot catalyze the ozone degradation of LEV; in the aerogel and ozone system of Example 4, under the condition of a reaction rate of 0.0929 min-1, levofloxacin can be completely removed within only 40 sec. It is 1.75 times higher than that of Fe-BC alone, which indicates that an abundance of pores in the aerogel provides the feasibility for the reaction sites. The results show that the non-metallic biochar aerogel framework has almost no catalytic effect on ozone, while the pure iron-based biochar has limited activation capability of catalyzing ozone. The reason may be put as follows: after the formation of a stable three-dimensional structure, additional doping centers for active components are provided, and the transfer rate of electrons in the material is increased. In addition, in the Fe-BC and ozone system, iron ions are dissolved out at 0.07 mg/L, which is about 35 times higher than that in the system of Example 4 (2.1 μg/L). If used for a long time, it must bring in serious ecological risks.

To explore the catalytic performance of catalysts with iron-based biochar in different doping ratios, biochar aerogels with iron-based biochar in different doping ratios are used in the catalytic ozone experiments. The results are shown in (c) of FIG. 10. The apparent rate constant K is calculated according to the pseudo-first-order reaction kinetics (shown in (d) of FIG. 10). As the doping amount of iron-based biochar gradually increases, the reaction rate also gradually rises from 0.050 min⁻¹ to 0.056 min⁻¹, until it reaches 0.093 min⁻¹ in the case of 4Fe-BC/3CS. However, the reaction rate of 5Fe-BC/3CS decreases to 0.060 min⁻¹, which may be due to the dilution effect of active sites as caused by continuously increasing the doping amount. In other words, the introduction of dopants increases the distance between active sites, reduces the density and catalytic activity of the active sites. The XPS results also proves this view. 4Fe-BC/3CS and 5Fe-BC/3CS are similar in the actual doping amount of iron (FIG. 8), but the contents of pyridine nitrogen and divalent iron in 5Fe-BC/3CS decrease. Moreover, it is also found that iron-based biochar powder cannot be coated on the surface of chitosan in the 5Fe-BC/3CS aerogel during the preparation of the material, which indicates that the covalent bond between the iron-based biochar powder and chitosan has reached a certain degree of saturation at this time; the further addition of the content of iron-based biochar is of little significance; instead, it will block the pores in the aerogel instead, which leads to lattice distortion and unstable crystal structure of the catalyst material, and further affects the exposure and activity of the active sites.

To understand the contribution of different oxidation-active substances in the examples, the present invention takes the aerogel in Example 4 for example to carry out free radical quenching experiments, and discusses the mechanism that the aerogel in the present invention catalyze ozone degradation of levofloxacin. As shown in (a) of FIG. 11, the commonly used quenching agents, furfuryl alcohol (FFA), p-chlorobenzoic acid (pCBA), kalium iodide (KI), and trichloromethane (CHCl₃) are used as quenching agents for ¹O₂, ·OH, electrons, and O₂⁻, respectively. After FFA is added, only 10.1% of LEV is degraded within 60 sec, and the reaction is significantly inhibited, with the reaction rate dropping to 0.002 min⁻¹. In addition, after pCBA, as a scavenging agent of · OH in the ozone system, is added to the reaction, only 19.7% of LEV is degraded within 60 sec, and the reaction is also largely inhibited. Considering that iron can undergo polycrystalline transformation to promote the course of electron transfer, KI is introduced as a chemical probe to block the electron transfer pathways. It is found that consistent with the FFA quenching experiment, only 10% of LEV is degraded, which indicates that the generation of ¹O₂ is largely affected by blocking the course of electron transfer. Finally, adding CHCl₃ to the system only slightly inhibits the experiment, which indicates that O₂⁻ is not the main active species in the 4Fe-BC/3CS & O₃ system.

ROS (reactive oxygen species) involved in the Example 4 & levofloxacin system is visually verified by using EPR. Different types of ROS are not detected in Example 4 or a O₃ system alone, which indicates that a single ozone system is a homogeneous system catalyzed by ozone alone. However, in the Example 4 & O₃ system, a large amount of ROS is generated, and 102 is captured by TEMP (2,2,6,6-tetramethylpiperidine oxide), which shows a typical EPR spectrum with three lines in the same intensity (1:1:1) ((b) in FIG. 11); ·OH is captured by DMPO (5,5-dimethyl-1-pyrroline-N-oxide), which shows a clear 1:2:2:1 signal peak ((c) in FIG. 11). In addition, adding DMPO to methanol to capture O₂⁻ only produces a mild signal peak ((d) in FIG. 11). Therefore, it can be concluded that the Example 4 & O₃ system can generate a large amount of ROS and promote the effective degradation of levofloxacin, while neither Example 4 nor the O₃ system alone can generate enough ROS to be captured in a short period of time.

One of the important evaluation criteria for practical applications is the reusability and stability of materials. The aerogel obtained in Example 4 shows excellent repeatability and maintains a degradation rate of 100% in ten cycles ((a) in FIG. 12). Moreover, as shown in (b) of FIG. 12, iron ions are dissolved out at 2.14 μg/L, which is much lower than 0.3 mg/L as required by the Chinese standard for drinking water (GB 5749-2022). In addition, the average reaction rate of 10 cycles is 0.076 min⁻¹. Therefore, compared with early research, 4Fe-BC/3CS is a more stable material that can be recycled multiple times, and the above findings demonstrate the potential of this catalytic material in the practical treatment of wastewater.

In addition, to prove the feasibility of practical applications, the actual tail water in rural areas is taken as the background, 16 kinds of antibiotics in the water are measured according to the standards for measurement use (DB 37/T 3738-2019), and classified to investigate the feasibility that the aerogel in the present invention catalyzes ozone to degrade different kinds of antibiotics. As shown in FIG. 13, after catalyzing ozone with the material in the present invention, sulfonamides, macrolides, tetracyclines, and Class III carcinogens on the list of carcinogens published by the International Agency for Research on Cancer of the World Health Organization decrease to below 10 ng/L; fluoroquinolones are greatly affected by actual root exudates, but the overall amount shows a downward trend.

### Example 6

The preparation method of the polycrystalline-iron-loaded porous biochar aerogel catalyst in this example comprises the following steps:
(1) using bamboo charcoal as a source of biochar, using ferric chloride as a source of iron, mixing and dispersing them in ultrapure water, adding hydrochloric acid to prevent iron from hydrolysis, mixing them at room temperature for 10 h, removing the supernatant, baking overnight in an oven, grinding and passing through a 100-mesh sieve, placing and calcining in a tube furnace under protection of inert gas, heating at a rate of 5° C./min to a temperature of 800° C. in the course of calcination, and maintaining the temperature for 1.0 h, thereby obtaining a polycrystalline iron biochar material;
(2) weighing 1.4 g of polycrystalline iron biochar, using chitosan as a nitrogen source and binder, weighing 1.2 g thereof, placing them into a beaker after weighing, adding 36.6 ml of deionized water, adding 1 ml of glacial acetic acid dropwise, then placing the beaker on a magnetic stirrer and stirring for 50 min, conducting ultrasonic treatment for 12 min after mixing uniformly;
(3) taking 1 ml of the sample in Step (2), adding it dropwise into a cryovial, freezing it at −20° C. in a refrigerator into a non-flowing state, then placing it into a freeze dryer, and freeze-drying it at −80° C. for 22 h;
(4) taking a certain amount of the sample in Step (3), placing the sample into a customized crucible, placing the crucible into a high-temperature tube furnace in N₂ atmosphere, heating it up to a temperature of 100° C. at a heating rate of 1° C./min, maintaining the temperature for 120 min, and then naturally cooling it down to room temperature, thereby obtaining a polycrystalline-iron-loaded porous biochar aerogel. In this example, due to the relatively high solubility of ferric chloride, it can be compounded at a high concentration with biochar. After high-temperature oxidation, magnetic iron oxide is formed. As a result, compared with Example 4, the iron clusters are larger, and the catalytic performance is slightly worse.

### Example 7

The preparation method of the polycrystalline-iron-loaded porous biochar aerogel catalyst in this example comprises the following steps:
(1) using bamboo charcoal as a source of biochar, using iron citrate as a source of iron, mixing and dispersing them in ultrapure water, adding 15 ml of citric acid to prevent iron from hydrolysis, mixing them at room temperature for 12 h, removing the supernatant, baking overnight in an oven, grinding and passing through a 100-mesh sieve, placing and calcining in a tube furnace under protection of inert gas, heating at a rate of 1° C./min to a temperature of 300° C. in the course of calcination, and maintaining the temperature for 4.0 h, thereby obtaining a polycrystalline iron biochar material;
(2) weighing 1.5 g of polycrystalline iron biochar, using chitosan as a nitrogen source and binder, weighing 1.5 g thereof, placing them into a beaker after weighing, adding 35.8 ml of deionized water, adding 0.7 ml of glacial acetic acid dropwise, then placing the beaker on a magnetic stirrer and stirring for 70 min, conducting ultrasonic treatment for 8 min after mixing uniformly;
(3) taking 1.5 ml of the sample in Step (2), adding it dropwise into a cryovial, freezing it at −20° C. in a refrigerator into a non-flowing state, then placing it into a freeze dryer, and freeze-drying it at −80° C. for 24 h;
(4) taking a certain amount of the sample in Step (3), placing the sample into a customized crucible, placing the crucible into a high-temperature tube furnace in N₂ atmosphere, heating it up to a temperature of 200° C. at a heating rate of 8° C./min, maintaining the temperature for 60 min, and then naturally cooling it down to room temperature, thereby obtaining a polycrystalline-iron-loaded porous biochar aerogel. Compared with Example 4, the biochar aerogel prepared in this example shows similar catalytic performance in the single-use case, but its reusability is inferior to that of Example 4.

### Example 8

The preparation method of the polycrystalline-iron-loaded porous biochar aerogel catalyst in this example comprises the following steps:
(1) using coconut shell charcoal as a source of biochar, using nonahydrate and iron nitrate as a source of iron, mixing and dispersing them in ultrapure water, adding 10 ml of 1M nitric acid to prevent iron from hydrolysis, mixing them at room temperature for 9 h, removing the supernatant, baking overnight in an oven, grinding and passing through a 100-mesh sieve, placing and calcining in a tube furnace under protection of inert gas, heating at a rate of 4° C./min to a temperature of 600° C. in the course of calcination, and maintaining the temperature for 2.5 h, thereby obtaining a polycrystalline iron biochar material;
(2) weighing 1.0 g of polycrystalline iron biochar, using carrageenan as a nitrogen source and binder, weighing 1.2 g thereof, placing them into a beaker after weighing, adding 37 ml of deionized water, adding 0.8 ml of glacial acetic acid dropwise, then placing the beaker on a magnetic stirrer and stirring for 50 min, conducting ultrasonic treatment for 15 min after mixing uniformly;
(3) taking 1 ml of the sample in Step (2), adding it dropwise into a cryovial, freezing it at −15° C. in a refrigerator into a non-flowing state, then placing it into a freeze dryer, and freeze-drying it at −70° C. for 24 h;
(4) taking a certain amount of the sample in Step (3), placing the sample into a customized crucible, placing the crucible into a high-temperature tube furnace in N₂ atmosphere, heating it up to a temperature of 150° C. at a heating rate of 5° C./min, maintaining the temperature for 80 min, and then naturally cooling it down to room temperature, thereby obtaining a polycrystalline-iron-loaded porous biochar aerogel. Although the bonding ability between coconut shell charcoal and iron is relatively weak, the inherent hardness of coconut shell charcoal is relatively high, giving it strong stress resistance and making it suitable for engineering conditions. Compared with Example 4, it has higher hardness, but the catalytic performance thereof is slightly worse.

### Example 9

The preparation method of the polycrystalline-iron-loaded porous biochar aerogel catalyst in this example comprises the following steps:
(1) using straw biochar as a source of biochar, using ferric chloride as a source of iron, mixing and dispersing them in ultrapure water, adding a certain amount of hydrochloric acid to prevent iron from hydrolysis, mixing them at room temperature for 10 h, removing the supernatant, baking overnight in an oven, grinding and passing through a 100-mesh sieve, placing and calcining in a tube furnace under protection of inert gas, heating at a rate of 4° C./min to a temperature of 400° C. in the course of calcination, and maintaining the temperature for 2.0 h, thereby obtaining a polycrystalline iron biochar material;
(2) weighing 1.6 g of polycrystalline iron biochar, using sodium alginate as a nitrogen source and binder, weighing 1.2 g thereof, placing them into a beaker after weighing, adding 36.4 ml of deionized water, adding 0.8 ml of glacial acetic acid dropwise, then placing the beaker on a magnetic stirrer and stirring for 60 min, conducting ultrasonic treatment for 10 min after mixing uniformly;
(3) taking 1 ml of the sample in Step (2), adding it dropwise into a cryovial, freezing it at −25° C. in a refrigerator into a non-flowing state, then placing it into a freeze dryer, and freeze-drying it at −85° C. for 20 h;
(4) taking a certain amount of the sample in Step (3), placing the sample into a customized crucible, placing the crucible into a high-temperature tube furnace in N₂ atmosphere, heating it up to a temperature of 130° C. at a heating rate of 4° C./min, maintaining the temperature for 90 min, and then naturally cooling it down to room temperature, thereby obtaining a polycrystalline-iron-loaded porous biochar aerogel.

As agricultural waste, straw is relatively low in collection and processing costs. After carbonization, straw biochar has a low density and small particle size, and the particle diameter is relatively small after it is compounded with iron. Therefore, a fine iron-based biochar catalyst can be formed. However, compared with Example 4, it has lower hardness, and the performance thereof is slightly worse.

To sum up, the aerogel prepared in the present invention has an abundance of pores and a relatively large specific surface area. At the same time, iron-based materials and carbon-based materials are crosslinked together by using ion exchange of a cross-linking agent. The loading of polycrystalline iron nanoparticles is relatively firm, which can effectively improve the mechanical strength and structural stability of the catalyst. In addition, the catalyst is simple in preparation process, green and non-polluting in the required raw materials, low in cost, easy to produce on a large scale, and applicable in such fields as treatment of organic pollutants in wastewater and deep purification treatment of drinking water.

1. A polycrystalline-iron-loaded porous biochar aerogel catalyst, which has an internal structure that is an overall honeycomb-like pore network structure, and comprises a porous biochar substrate, with polycrystalline iron nanoparticles loaded on biochar layers through Fe—C bonds.

2. The polycrystalline-iron-loaded porous biochar aerogel catalyst of claim 1, wherein the polycrystalline iron has a crystal plane that includes, but is not limited to, (220) crystal plane of Fe₃O₄, (002) crystal plane of Fe₃C, (211) crystal plane of Fe₃C, and (031) crystal plane of Fe₂O₃.

3. The polycrystalline-iron-loaded porous biochar aerogel catalyst of claim 2, wherein different crystals of the polycrystalline iron alternately grow inside the biochar layers, and interlaced reticular lattice fringes are visible under a transmission electron microscope;
and/or the polycrystalline iron nanoparticles have a loading amount of 5% to 15% of catalyst mass;
and/or the polycrystalline iron has a content of 0.27 at % to 37 at % of the total amount of the catalyst, wherein Fe(III) accounts for 38 at % to 54 at % of the total iron content, Fe(II) accounts for 17 at % to 31 at % of the total iron content, and Fe₃C comprises 17 at % to 31 at % of the total iron content.

4. The polycrystalline-iron-loaded porous biochar aerogel catalyst of claim 1, wherein the polycrystalline iron nanoparticles have a particle size of 1 nm to 10 nm; and/or pores on the biochar substrate have a diameter of 50 μm to 100 μm.

5. The polycrystalline-iron-loaded porous biochar aerogel catalyst of claim 1, wherein the biochar aerogel has a contact angle less than 88°;
and/or the biochar aerogel has an impedance value below 11 Ω;
and/or the biochar aerogel has an ID/IG value greater than 0.85 in Raman spectrum, and new peaks appear at positions 877.74 cm⁻¹, 935.76 cm⁻¹, and 1004.97 cm⁻¹ in in situ Raman spectrum thereof after contact with O₃ in water.

6. The polycrystalline-iron-loaded porous biochar aerogel catalyst of claim 2, wherein the biochar aerogel has a contact angle less than 88°;
and/or the biochar aerogel has an impedance value below 11 Ω;
and/or the biochar aerogel has an ID/IG value greater than 0.85 in Raman spectrum, and new peaks appear at positions 877.74 cm⁻¹, 935.76 cm⁻¹, and 1004.97 cm⁻¹ in in situ Raman spectrum thereof after contact with O₃ in water.

7. The polycrystalline-iron-loaded porous biochar aerogel catalyst of claim 3, wherein the biochar aerogel has a contact angle less than 88°;
and/or the biochar aerogel has an impedance value below 11;
and/or the biochar aerogel has an ID/IG value greater than 0.85 in Raman spectrum, and new peaks appear at positions 877.74 cm⁻¹, 935.76 cm⁻¹, and 1004.97 cm⁻¹ in in situ Raman spectrum thereof after contact with O₃ in water.

8. A preparation method of the polycrystalline iron-loaded porous biochar aerogel catalyst of claim 1, comprising:
contacting/mixing iron-based biochar with a crosslinking agent in an aqueous solution to form an iron-based-biochar-crosslinking-agent mixture; wherein the iron-based biochar comprises a biochar substrate and polycrystalline iron nanoparticles loaded on biochar layers;
applying freeze-drying treatment to the iron-based-biochar-crosslinking-agent mixture to form honeycomb-like voids in the biochar layers, thereby obtaining iron-based biochar aerogel;
calcining the iron-based biochar aerogel in an inert atmosphere to load the polycrystalline iron nanoparticles on the biochar layers through Fe—C bonds, thereby obtaining the polycrystalline iron-loaded porous biochar aerogel catalyst.

9. The preparation method of the polycrystalline iron-loaded porous biochar aerogel catalyst of claim 8, wherein the iron-based biochar has a specific surface area of 150 m²/g to 250 m²/g;
and/or the crosslinking agent includes, but is not limited to, chitosan, carrageenan, and sodium alginate, and mass ratio of the iron-based biochar to the crosslinking agent is (2-5): (1-5);
and/or the biochar includes, but is not limited to, bamboo charcoal, straw biochar, and coconut shell charcoal;
and/or organic acid or inorganic acid is added to the aqueous solution, and the ratio of the iron-based biochar, the crosslinking agent, the organic acid or inorganic acid, and water is (0.8 g to 2 g): (0.8 g to 2 g): (0.4 ml to 0.8 ml): (38 ml to 35.2 ml);
and/or said applying freeze-drying treatment to the iron-based-biochar-crosslinking-agent mixture comprises: first freezing the iron-based-biochar-crosslinking-agent mixture at −15° C. to −25° C., and then freeze-drying at −70° C. to −85° C.;
and/or said calcining the iron-based biochar aerogel in an inert atmosphere comprises: heating the iron-based biochar aerogel to a temperature of 100° C. to 200° C. at a rate of 1° C./min to 8° C./min, maintaining the temperature for 1.0 h to 2.0 h, and then cooling to room temperature.

10. The preparation method of the polycrystalline iron-loaded porous biochar aerogel catalyst of claim 8, wherein the iron-based biochar is prepared in a chemical deposition method or a mechanical ball milling method.

11. A preparation method of the polycrystalline iron-loaded porous biochar aerogel catalyst of claim 5, comprising:
contacting/mixing iron-based biochar with a crosslinking agent in an aqueous solution to form an iron-based-biochar-crosslinking-agent mixture; wherein the iron-based biochar comprises a biochar substrate and polycrystalline iron nanoparticles loaded on biochar layers;
applying freeze-drying treatment to the iron-based-biochar-crosslinking-agent mixture to form honeycomb-like voids in the biochar layers, thereby obtaining iron-based biochar aerogel;
calcining the iron-based biochar aerogel in an inert atmosphere to load the polycrystalline iron nanoparticles on the biochar layers through Fe—C bonds, thereby obtaining the polycrystalline iron-loaded porous biochar aerogel catalyst.

12. The preparation method of the polycrystalline iron-loaded porous biochar aerogel catalyst of claim 11, wherein the iron-based biochar has a specific surface area of 150 m²/g to 250 m²/g;
and/or the crosslinking agent includes, but is not limited to, chitosan, carrageenan, and sodium alginate, and mass ratio of the iron-based biochar to the crosslinking agent is (2-5): (1-5);
and/or the biochar includes, but is not limited to, bamboo charcoal, straw biochar, and coconut shell charcoal;
and/or organic acid or inorganic acid is added to the aqueous solution, and the ratio of the iron-based biochar, the crosslinking agent, the organic acid or inorganic acid, and water is (0.8 g to 2 g): (0.8 g to 2 g): (0.4 ml to 0.8 ml): (38 ml to 35.2 ml);
and/or said applying freeze-drying treatment to the iron-based-biochar-crosslinking-agent mixture comprises: first freezing the iron-based-biochar-crosslinking-agent mixture at −15° C. to −25° C., and then freeze-drying at −70° C. to −85° C.;
and/or said calcining the iron-based biochar aerogel in an inert atmosphere comprises: heating the iron-based biochar aerogel to a temperature of 100° C. to 200° C. at a rate of 1° C./min to 8° C./min, maintaining the temperature for 1.0 h to 2.0 h, and then cooling to room temperature.

13. The preparation method of the polycrystalline iron-loaded porous biochar aerogel catalyst of claim 11, wherein the iron-based biochar is prepared in a chemical deposition method or a mechanical ball milling method.
